(19) United States
(12) Patent Application Publication
(10) Pub. No.: US 2025/0243402 A1
(43) Pub. Date: Jul. 31, 2025

(54) SLOW REACTING ACIDIZING COMPOSITIONS AND METHODS

(71) Applicant: ENERGY SOLUTIONS (US) LLC, Princeton, NJ (US)

(72) Inventors: Sumit Bhaduri, Princeton, NJ (US); Qi Qu, Tomball, TX (US); Anna Jensen, Princeton, NJ (US)

(73) Assignee: ENERGY SOLUTIONS (US) LLC, Princeton, NJ (US)

(21) Appl. No.: 19/015,573

(22) Filed: Jan. 9, 2025

Related U.S. Application Data
(60) Provisional application No. 63/625,770, filed on Jan. 26, 2024.

(51) Int. Cl. C09K 8/74; C09K 8/54; E21B 41/02; E21B 43/27

(52) U.S. Cl. CPC C09K 8/74; C09K 8/54; E21B 41/02; E21B 43/27; C09K 2208/30; C09K 2208/32

(57) ABSTRACT

Provided is an acid retarder composition, a well treatment fluid, and a method of treating a subterranean formation for slow-reacting acidizing operations. An acid retarder composition for acidizing a subterranean formation includes a nitrogen-containing derivative of carbonic acid, a quaternary ammonium compound, and a surfactant. Well treatment fluids include an aqueous medium, an acid, and an acid retarder composition including a nitrogen-containing derivative of carbonic acid, a quaternary ammonium compound, a surfactant. Methods of treating a subterranean formation include injecting a well treatment fluid including an aqueous medium, an acid, and an acid retarder composition including a nitrogen-containing derivative of carbonic acid, a quaternary ammonium compound, and a surfactant into a subterranean formation.

### BACKGROUND

There are several stimulation treatments for increasing oil production, such as hydraulic fracturing and acidizing. Hydraulic fracturing includes pumping specially engineered fluids at high pressures into the formation in order to create fissures that are held open by the proppants present in the fluid once the treatment is completed.

In contrast, acidizing is generally used for low permeability formations. It includes injecting acid into the formation. The acid then reacts with soluble substances of the formation, creating pathways for oil conductivity. Often organic acids are used at higher temperature matrix acidizing (>300 F); however, the poor dissolution of rock using acetic acid renders the treatment less desirable. Slower reacting hydrochloric acid treatment fluids are hence highly desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an acid retarder composition for acidizing a subterranean formation comprising nitrogen-containing derivative of carbonic acid, a quaternary ammonium compound, and a surfactant.

In another aspect, embodiments disclosed herein relate to a well treatment fluid comprising an aqueous medium, an acid, and an acid retarder composition comprising nitrogen-containing derivative of carbonic acid, a quaternary ammonium compound, a surfactant.

In another aspect, embodiments disclosed herein relate to a method of treating a subterranean formation comprising injecting a well treatment fluid comprising an aqueous medium, an acid, and an acid retarder composition comprising nitrogen-containing derivative of carbonic acid, a quaternary ammonium compound, and a surfactant into a subterranean formation.

Other aspects and advantages of the claimed subject matter will be apparent from the following description and the appended claims.

### DETAILED DESCRIPTION

In one aspect, embodiments disclosed herein relate to slow reacting acidizing compositions, or well treatment fluids, used for dissolving carbonate containing rocks in a subterranean formation. Acidizing compositions according to the present disclosure may benefit from the ability of a strong acid, such as hydrochloric acid, to dissolve rock formations while tempering the activity of the acid using an acid retarder composition which allows deeper penetration of the well treatment fluid from the wellbore into the formation. The acidizing compositions exhibit a synergistic effect in reducing the reactivity of the acid in the formulation. The acidizing compositions further exhibit a synergistic effect of in-situ acid diversion as the viscoelastic surfactant used increases the viscosity of the fluid as the acid is spent dissolving away the matrix rock, allowing for the creation of longer wormholes with less branching.

### Acid Retarder Composition

In one aspect, acid retarder compositions comprise a nitrogen-containing derivative of carbonic acid, a quaternary ammonium compound, and a surfactant.

In one or more embodiments, acid retarder compositions comprise a urea or a urea derivative, a quaternary ammonium compound, and a surfactant. In one or more embodiments, acid retarder compositions comprise a urea or a urea derivative and/or a quaternary ammonium compound and/or a surfactant.

In one or more embodiments, acid retarder compositions comprise a nitrogen-containing derivative of carbonic acid, which may be a urea or a urea derivative. In one or more embodiments, acid retarder compositions comprise urea or a urea derivative such as amides, carboxylic acids, and alcohols. The urea or a urea derivative may be, for example, selected from the group consisting of urea, thiourea, alkyl substituted ureas such as dimethyl urea and N-phenyl urea, salts of urea or substituted ureas such as urea phosphate, resin containing urea compounds such as urea formaldehyde, urea tetrakis(hydroxymethyl)phosphonium sulfate (THPS) condensates such as those in U.S. Pat. No. 4,228,100, thiourea, guanidinium and guanidinium salts such as guanidinium hydrochloride, and formamide derivatives. In one or more embodiments, the acid retarder composition comprises urea.

In one or more embodiments, the urea or a urea derivative may be present in an amount ranging from greater than 0.1 wt % to 60 wt %, relative to the total weight of the acid retarder composition, for example from a lower limit of any of greater than 0.1, 1, 5, 10, 15, 20, 25, or 30 wt % to an upper limit of any of 30, 35, 40, 45, 50, 55, or 60 wt %, where any lower limit can be used in combination with any suitable upper limit.

The quaternary ammonium compound may be selected from the group consisting of alkyl ammonium salts and derivatives thereof. In one or more embodiments, the quaternary ammonium compound may be choline chloride.

In one or more embodiments, the quaternary ammonium compound may be present in an amount ranging from greater than 0.1 wt % to 60 wt %, i.e. a saturated aqueous solution, relative to the total weight of the acid retarder composition, for example from a lower limit of any of greater than 0.1, 1, 5, 10, 15, 20, 25, or 30 wt % to an upper limit of any of 30, 35, 40, 45, 50, 55, or 60 wt %, where any lower limit can be used in combination with any suitable upper limit.

In one or more embodiments, the surfactant is a viscoelastic surfactant. The surfactant may be an amphoteric or zwitterionic surfactant. The surfactant may be selected from the group consisting of betaines, sultaines, and amidoamine oxides. The surfactant may be, for example, tallow alkyl amidopropyl dimethylamine oxide. In one or more embodiments, the surfactant is a betaine surfactant. In one or more embodiments, the surfactant is selected from oleyl amido propyl betaine and erucyl amido propyl betaine.

In one or more embodiments, the surfactant may be present in an amount ranging from greater than 0.1 gpt to 40 gpt, relative to the total amount of the acid retarder composition, for example from a lower limit of any of greater than 0.1, 0.5, 1, 2, 3, 4, 5, 10, 15, or 20 gpt to an upper limit of any of 20, 25, 30, 35, or 40 gpt, where any lower limit can be used in combination with any suitable upper limit.

### Acid Retarder Composition Properties

In one or more embodiments, acid retarder compositions have a pH ranging from 8 to 10. Acid retarder compositions may have a pH of, for example, about 9.

In one or more embodiments, acid retarder compositions have a density ranging from 8 to 10 lb/gal. Acid retarder compositions may have a density of, for example, about 9 lb/gal.

### Method of Preparing an Acid Retarder Composition

In one or more embodiments, acid retarder compositions may be prepared via mixing and dissolution to form an aqueous slurry or solution. The quaternary ammonium compound may be provided as an aqueous solution or a dry powder to which water or an aqueous fluid may be added to prepare a solution. To the quaternary ammonium solution, a nitrogen-containing derivative of carbonic acid, such as urea or a urea derivative, is added and mixed to form a slurry. A surfactant may then be added to the slurry and mixed to form a homogeneous solution.

### Well Treatment Fluid

In an aspect, one or more embodiments relate to a well treatment fluid. The well treatment fluid may comprise an aqueous medium, acid, and an acid retarder composition, the acid retarder composition including a nitrogen-containing derivative of carbonic acid, a quaternary ammonium compound, and a surfactant. The acid retarder composition may be included in the well treatment fluids in an amount sufficient to provide the desired reduction activity of the acid. The acid retarder composition may be added to the aqueous well treatment fluid in an amount ranging from 0.1 wt % to 60 wt %. For example, the acid retarder composition may be present in the well treatment fluid in an amount ranging from 0.1 wt % to 60 wt %, for example from a lower limit of any of 0.1, 1, 5, 10, 15, 20, 25, or 30 wt % to an upper limit of any of 30, 35, 40, 45, 50, 55, or 60 wt %, where any lower limit may be used in combination with any suitable upper limit.

In one or more embodiments, the well treatment fluid comprises an acid. Acids included in the well treatment fluid may be organic or inorganic acids, and are preferably strong acids. In one or more embodiments, the acid is selected from the group consisting of hydrochloric acid, hydrobromic acid, hydrofluoric acid, acetic acid, formic acid, phosphoric acid, sulfuric acid, nitric acid, alkane sulfonic acid, arylsulfonic acid, carboxylic acid, acrylic acid, lactic acid, malonic acid, citric acid, tartaric acid, and glycolic acid. In one or more embodiments, the acid is hydrochloric acid.

In one or more embodiments, the acid may be present in an amount ranging from greater than 0.1 wt % to 50 wt %, relative to the total weight of the well treatment fluid, for example from a lower limit of any of greater than 0.1, 1, 5, 10, 15, or 20 wt % to an upper limit of any of 20, 30, 40, or 50 wt %, where any lower limit can be used in combination with any suitable upper limit.

A well treatment fluid may be produced, for example, by providing an acid retarder composition according to the present disclosure and diluting the acid retarder composition with an aqueous medium, and optionally mixing one or more optional additives. A well treatment fluid may be produced by providing the acid retarder composition as a blend or may be produced by addition of each component of the acid retarder composition individually to the well treatment fluid. Further, any two or more components of the acid retarder composition may be provided as a blend, and the remaining components may be provided individually to produce the well treatment fluid. Considering that one or more (or even all) of the acid retarder components may be added directly to the well treatment fluid, the amounts of the nitrogen-containing derivative of carbonic acid, quaternary ammonium compound, and surfactant as individual components relative to the well treatment fluid may be calculated from the aforementioned ranges of their make-up of the acid retarder composition and the aforementioned amount of acid retarder composition in the well treatment fluid.

The aqueous medium used in the well treatment fluids can be freshwater, saltwater (e.g., water containing one or more salts dissolved therein), brine (e.g., produced from subterranean formations), seawater, pit water, pond water or the like, or combinations thereof. Generally, the aqueous medium used may be from any source, provided that it does not contain an excess of compounds that may adversely affect other components in the aqueous treatment fluid or the formation itself.

In one or more embodiments, the aqueous medium, or slurry, may be present in an amount ranging from greater than 0.1 wt % to 50 wt %, relative to the total weight of the well treatment fluid, for example from a lower limit of any of greater than 0.1, 1, 5, 10, 15, 20, or 25 wt % to an upper limit of any of 30, 35, 40, 45, or 50 wt %, where any lower limit can be used in combination with any suitable upper limit.

The acid retarder compositions according to the present disclosure provide a particular advantage over conventional acid retarders, such as those using urea and/or salts alone.

Additional additives can be included in the aqueous well treatment fluids as deemed appropriate by one of ordinary skill in the art. Examples of such additives include, but are not limited to, corrosion inhibitors, proppant particulates, fluid loss control additives, and surfactants. In fracturing embodiments, proppant particulates may be included in the well treatment fluids to prevent the fracture from closing when the hydraulic pressure is released.

In matrix or fracturing acidizing treatments, a corrosion inhibitor may be included. Corrosion inhibitors may be, for example, pyridine or quaternary quinoline corrosion inhibitors. In one or more embodiments, the corrosion inhibitors are present in an amount ranging from 2 to 20 gpt.

The well treatment fluids can be used in any subterranean treatment where the reduction of activity of an acid is desired. Such subterranean treatments include, but are not limited to, drilling operations, stimulation treatments (e.g., fracturing treatments, acidizing treatments, fracture acidizing treatments), and completion operations. Those of ordinary skill in the art, with the benefit of this disclosure, will be able to recognize a suitable subterranean treatment where acid retardation may be desired.

### Method of Treating a Subterranean Formation

In one or more embodiments, a method of treating a portion of a subterranean formation includes providing the well treatment fluid and introducing the well treatment fluid into the portion of the subterranean formation. In some embodiments, the well treatment fluid can be introduced into the portion of the subterranean formation at a rate and pressure which is not sufficient to create or enhance one or more fractures in the portion of the subterranean formation, i.e. matrix acidizing. The retarded action of the acid may then allow for enhanced distribution of the well treatment fluid within the subterranean formation for the creation of channels for conducting the flow of oil. In some embodiments, the well treatment fluid can be introduced into the portion of the subterranean formation at a rate and pressure sufficient to create or enhance one or more fractures in the portion of the subterranean formation, i.e. acid fracturing.

The portion of the subterranean formation that the well treatment fluid is introduced will vary dependent upon the particular subterranean treatment. For example, the portion of the subterranean formation may be a section of a well bore, for example, in a well bore cleanup operation. In the stimulation embodiments, the portion may be the portion of the subterranean formation to be stimulated.

### EXAMPLES

Limestone core discs used were Indiana limestone cores having D=1.75″ and l=0.75″, a permeability of 70-110 mD, and a weight ranging from 60.686 g-61.233 g and an ˜1% variation of the weight of the formation core material. In each dissolution test, 100 cc of 28% HCl treatment fluid was used.

### Acid Blend Preparation

To a 1.2 L plastic jar was weighed out 200 g of a 75% choline chloride solution. To the jar while mixing at 800 rpm on an overhead stirrer was added 157 g urea, added over ˜5 min. Addition of urea results in cooling own of the solution (endothermic). A few particles of undissolved urea still remained at this time. To the cool slurry while mixing at 800 rpm was added 357 g Surfactant. The entire mixture was stirred for 1 h by which a pale yellow homogeneous stable solution was obtained. When surfactant was S1 (Visclear A5205 from Syensqo), the measured pH of the final pale yellow colored solution was 9.2; density was determined to be 8.9 lb/gal. When surfactant was S2 (Visclear A7400 from Syensqo), the measured pH of the final pale yellow colored solution was 8.52; density was determined to be 8.9 lb/gal.

### Example 1: Performance Correlation of the Retarding Surfactant S1

Tests run at 150 F in presence of 28% HCl and limestone core disc. Percent dissolution of limestone core disc is presented in Table 1. A slowing down of the acid reaction with the carbonate mineral is evidenced by reduction of dissolution. This is reflected by the % Dissolution value calculated for each experimental core disk. Several retarder enhancers have been tested. The general chemical classes include saturated ammonium brine and urea. The synergy of the three-component system is indicated from a close investigation of the data in Table 1.

TABLE 1

| Surfactant S1 | Dissolution |
|---|---|
| (gpt) | (%) |
| 5 | 8.29 |
| 10 | 5.95 |
| 20 | 6.13 |

### Example 2: Limestone Disc Dissolution Reduction Testing

Tests run at 150 F using limestone core disc. Though urea by itself resulted in increased disc dissolution, due to its basic nature, combining with a LFW (low free water quat) resulted in improvement of performance (−25% to +8%). The presence of VES in combination with saturated ammonium brines and urea resulted in the best performing additive.

TABLE 2

| | | | | Reduction |
|---|---|---|---|---|
| | | | | in |
| | Quaternary | | Retarding | Dissolution |
| Formulation | Ammonium | Urea | Surfactant | (%) |
| 1 | No | No | No | 0 |
| 2 | No | Yes | No | −25 |
| 3 | Yes | No | No | 26 |
| 4 | No | No | Yes | 83 |
| 5 | Yes | Yes | No | 8 |
| 6 | Yes | No | Yes | 87 |
| 7 | Yes | Yes | Yes | 95 |

### Example 3: Component Solubility in Aqueous Media

Investigation of the ammonium quats reveals an improvement of performance when saturated ammonium salts are used. Though all quaternary ammoniums are water soluble, specific ones that have the highest water solubility and close to saturation conditions are desirable.

TABLE 3
Water solubility of saturated ammonium brines

| | Improvement |
|---|---|
| | in Solubility |
| | in Aqueous |
| Component | Media (%) |
| Ammonium Chloride | baseline |
| Tetramethyl Ammonium | 35 |
| Chloride | |
| Choline Chloride | 102 |

### Example 4: Acid Reactivity with Carbonate

Creation of low corrosivity acids reduces corrosion on tubulars and the metal used to pump the acidizing fluid down the subterranean formation. Several corrosion inhibitor intermediates have been tested and found to be completely compatible with the retarding surfactant and enhancer mixtures. Table 4 summarizes the corrosion tests run with L80 metal coupons at 150 F. Tests run at 150 F with 28% HCl+20% by wt. the brine solution.

TABLE 4
Performance correlation of saturated ammonium brines

| | Reactivity |
|---|---|
| | Reduction |
| Component | (%) |
| Ammonium Chloride | 11 |
| Tetramethyl Ammonium | 20 |
| Chloride | |
| Choline Chloride | 26 |

### Example 5: Corrosion Tests

As can been from the summary in Table 5, the Formulation #1 (20 gpt Retarding Surfactant S1+20 wt. % urea+30 wt % choline chloride) displays significantly less corrosion than the baseline (<1% vs 9%). This further establishes the slow reactive nature of the proposed formulations.

TABLE 5
Summary of corrosion tests run with L80 coupons in
15% HCl at 150F for 6 h

| | | Initial | Final | W.t | % Wt. |
|---|---|---|---|---|---|
| Coupon | Fluid | Wt. | Wt. | Loss | Loss |
| 52 | 15% HCl | 28.557 | 26.1376 | 2.4194 | 8.47 |
| | (baseline) | | | | |
| 54 | 5 gpt Cl | 28.564 | 28.5562 | 0.0078 | 0.3 |
| 58 | 20 gpt F #1 | 28.6125 | 28.3413 | 0.2712 | 0.95 |
| 51 | 5 gpt Cl + 20 gpt | 28.5438 | 28.517 | 0.0217 | 0.09 |
| | F#1 | | | | |

### Example 6

The ability of the retarding surfactant along with retarder enhancers to perform to slow down acid reactivity was also determined using Formulation #2 (10 gpt Retarding surfactant+1:1 combination of a 0.4% retarder enhancer mixture containing urea and choline chloride. These test data are summarized in Table 6. As can be discerned, the slow reactivity of retarding surfactant and retarder enhancer is not compromised by the presence of the corrosion inhibitor, CI.

TABLE 6
Dissolution Data for static dissolution tests run at
150F using limestone core disc

| | % |
|---|---|
| Formulation | Dissolution |
| Baseline (28% HCl) | 37.2 |
| +20 gpt F#2 | 6.02 |
| +20 gpt F#2 + 5 gpt | 6.09 |
| Cl | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. An acid retarder composition for acidizing a subterranean formation comprising:
a nitrogen-containing derivative of carbonic acid,
a quaternary ammonium compound, and
a surfactant.

2. The composition according to claim 1, wherein the surfactant is a viscoelastic surfactant.

3. The composition according to claim 2, wherein the viscoelastic surfactant is selected from the group consisting of amido propyl betaines.

4. The composition according to claim 3, wherein the amido propyl betaine is selected from the group consisting of oleyl amido propyl betaine and erucyl amido propyl betaine.

5. The composition according to claim 1, wherein the quaternary ammonium compound is choline chloride.

6. The composition according to claim 1, wherein the nitrogen-containing derivative of carbonic acid is urea or a urea derivative.

7. The composition according to claim 1, wherein the urea or urea derivative is present in an amount ranging from 0.1 wt % to 60 wt %, relative to the total weight of the composition.

8. The composition according to claim 1, wherein the quaternary ammonium compound is present in an amount ranging from 0.1 wt % to 60 wt %, relative to the total weight of the composition.

9. The composition according to claim 1, wherein the surfactant is present in an amount ranging from 0.1 to 40 gpt, relative to the total amount of the composition.

10. A well treatment fluid comprising:
an aqueous medium,
an acid, and
an acid retarder composition of claim 1.

11. The well treatment fluid according to claim 10, wherein the acid is selected from the group consisting of hydrochloric acid, hydrobromic acid, hydrofluoric acid, acetic acid, formic acid, phosphoric acid, sulfuric acid, nitric acid, alkane sulfonic acid, arylsulfonic acid, carboxylic acid, acrylic acid, lactic acid, malonic acid, citric acid, tartaric acid, and glycolic acid.

12. The well treatment fluid according to claim 10, wherein the acid is present in an amount ranging from 0.1 wt % to 50 wt %, relative to the total weight of the well treatment fluid.

13. The well treatment fluid according to claim 10, wherein the acid retarder composition is present in an amount ranging from 0.1 wt % to 60 wt %, relative to the amount of acid present in the well treatment fluid.

14. The well treatment fluid according to claim 10, wherein the aqueous fluid is present in an amount ranging from 0.1 to 50 wt %, relative to the total weight of the well treatment fluid.

15. The well treatment fluid according to claim 10, further comprising a corrosion inhibitor.

16. A method of treating a subterranean formation comprising:
injecting the well treatment fluid of claim 10 into a subterranean formation.

17. The method of claim 16, wherein the well treatment fluid is injected during an acidizing operation.
